(19) United States
(12) Patent Application Publication
(10) Pub. No.: US 2010/0010879 A1
(43) Pub. Date: Jan. 14, 2010

(54) PRODUCTIVITY OPERATIONS SYSTEM AND METHODOLOGY FOR IMPROVING MANUFACTURING PRODUCTIVITY

(75) Inventors: Carl A. Roebke, Columbus, MI (US); Anthony Cercone, Tecumseh (CA); Kevin Bennett, Great Totham (GB); Gordon Macaulay, Clinton Township, MI (US); Adrian Price, Lima, OH (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 12/169,227

(22) Filed: Jul. 8, 2008

(51) Int. Cl. G06Q 10/00

(52) U.S. Cl. 705/11; 705/7

(57) ABSTRACT

A method for improving productivity operations may include receiving elements of a first and second array which produces a productivity matrix. Further included may be receiving matrix events having an input, an output, and an activity step, receiving the input and activity step, and outputting the output. The input, activity step, and output may enable standardization of productivity improvement. A method may also include supplying elements of the first and second array to produce a productivity matrix and generating matrix events which include an input, output, and activity step. A system for improving productivity operations may include a computer configured to receive elements of the first and second arrays which produces a productivity matrix. The computer may receive matrix events having an input, output, and activity step, receive the input and activity step, and output an output all of which together may enable standardization of productivity improvement.

### BACKGROUND

1. Technical Field

One or more embodiments of the present invention relates to a productivity operating system and method for improving manufacturing productivity.

2. Background

Productivity is an important element to any business entity. Managers and executives continuously strive to improve productivity in order to make their organization competitive and a leader in their field. Improving productivity can be an expensive and time consuming initiative. Thus, companies are fully focused on finding tools to effectively decrease costs while increasing productivity.

### SUMMARY

One aspect of the present invention is a computer-implemented method and system for generating a productivity matrix which includes multiple arrays and elements to standardize productivity improvement. Another aspect of the present invention is generating a variety of events comprised of inputs, activity steps, and outputs for accomplishing the standardization of productivity improvements.

In one embodiment, there may be a computer-implemented method for improving manufacturing productivity of a business entity's operations. The method may include receiving at least two elements of a first array and at least two elements of a second array. The first and second arrays may be interrelated to produce a productivity matrix. The method may further include receiving a plurality of matrix events. Each matrix event may be interrelated to an element of the first and second arrays. Furthermore, each matrix event may also include at least one input, at least one output, and at least one activity step for obtaining the output from the input. The at least one input and the at least one activity step for each matrix event may be received and the at least one output for each matrix event may be outputted. The input, activity step, and output of each matrix event together may enable standardization of a business entity's operations to improve productivity improvement.

The elements of the first array of the matrix may be in a hierarchical scheme comprising a plurality of the business entity's work streams based on a span of control of at least one employee of the business entity assigned to each work stream. Non-limiting examples of a business entity's work streams may include a commodity focus, a production line focus, and a functional focus. The second array may be a plurality of event objectives associated with each work stream to serve as a guide for standardizing the business entity's improvement and productivity operations. Non-limiting examples of event objectives may include metrics, problem identification, problem analysis, problem solving, follow-up, and roles and responsibilities.

The at least one input to the matrix events may include productivity related data, the at least one activity step may include organizing the inputted productivity related data, and the output may include one or more productivity metrics generated based on the inputted and organized productivity related data. The metric may be used for identifying and further evaluating one or more constraints affecting the business entity's productivity.

Additionally, the at least one input may be a plurality of data generated from one or more productivity metrics associated with one of at least two elements of the first array, the at least one activity step may be a value stream mapping of the element, and the at least one output may be one or more productivity constraints affecting the productivity of the element.

The plurality of matrix events may include at least one productivity constraint in the business entity's operations. Furthermore, the coordination of the at least one input, the at least one activity step, and the at least one output of each of the plurality of matrix events may serve to identify and address the at least one productivity constraint.

In another embodiment, there may be a computer-implemented system for improving manufacturing productivity of a business entity's operations including a computer configured to receive at least two elements of a first array and at least two elements of a second array. The first and second arrays may be interrelated to produce a productivity matrix. The system computer may be further configured to receive a plurality of matrix events and each may be interrelated to an element in the first and second arrays. Furthermore, each matrix event may includes at least one input, at least one output, and at least one activity step for obtaining the output from the input. The computer may further receive at least one input and at least one activity step for each matrix event and output at least one output for each matrix event. The input, activity step, and output of each matrix event together may enable standardization of a business entity's operations to improve productivity improvement.

In another embodiment, there may be a computer-implemented method for improving manufacturing productivity of a business entity's operations. The method may include supplying at least two elements of a first array and at least two elements of a second array. The first array and second array may be interrelated to produce a productivity matrix. The method may further include generating a plurality of matrix events. Each matrix event may be interrelated to an element of the first array and second arrays. Furthermore, each matrix event may include at least one input, at least one output, and at least one activity step for obtaining the output from the input.

These and other aspects of the present invention will be better understood in view of the attached drawings and following detailed description of the invention.

### BRIEF DESCRIPTION OF THE DRAWINGS

The features of the present invention which are believed to be novel are set forth with particularity in the appended claims. The present invention, both as to its organization and manner of operation, together with further object and advantages thereof, may best be understood with reference to the following description, taken in connection with the accompanying drawings, which:

FIG. 1 is an environment, i.e., a computer system, suitable for implementing one or more embodiments of the present invention;

FIG. 2 is an exemplary schematic diagram of a number of features of one or more embodiments of the present invention;

FIG. 3 is an exemplary schematic diagram of a number of features of one or more embodiments of the present invention;

FIG. 4 is an exemplary schematic diagram of a number of features of one or more embodiments of the present invention; and

FIG. 5 is an exemplary schematic diagram of a number of features of one or more embodiments of the present invention.

### DETAILED DESCRIPTION OF EMBODIMENTS

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

At least one problem with current productivity standards is a lack of a standardized approach to improving productivity. Accordingly, the lack of standardization requires constant relearning of productivity fundamentals, generates instability in the productivity process, and does not provide for proper allocation of resources to support key manufacturing areas. Thus, current productivity processes would benefit from a standardized approach to improving productivity. Manufacturing organizations can use a structured framework through which information can flow and events can be generated at all levels of the business organization.

Accordingly, a productivity operating system may provide for maintained and continuously improved productivity levels in a business environment. The present invention may be suitable for any business environment desiring to improve productivity levels, but is exemplified herein an automotive manufacturing environment.

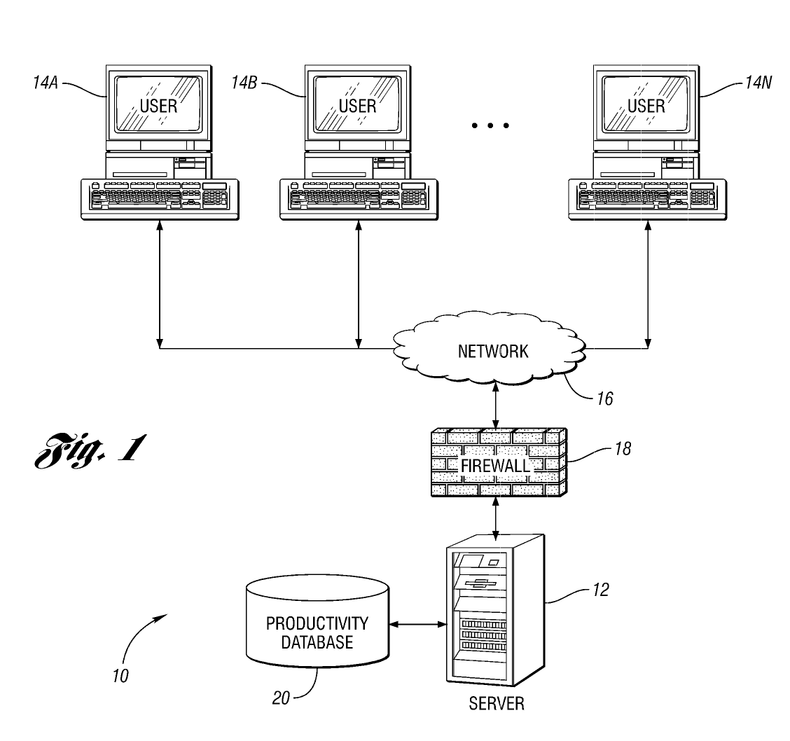

FIG. 1 shows an environment suitable for implementing one or more embodiments of the present invention. The various embodiments of the invention may be implemented in a computer system 10. The system 10 may include at least one computer 12 operable to receive at least two elements of a first array and at least two elements of a second array of a productivity matrix. The first and second arrays may be interrelated to produce the productivity matrix.

Furthermore, the computer 12 may receive a plurality of matrix events. Each matrix event may be interrelated to an element in the arrays of the matrix. Each matrix event may include at least one input, at least one output, and at least one activity step for obtaining the output from the input. The at least one computer 12 may also receive the at least one input and the at least one activity step for each matrix event. Finally, the computer 12 may output the at least one output for each matrix event.

In one embodiment, the at least one computer may be a server computer 12 which houses a database 20 for receiving the inputs and activity steps and retrieving the output. The output may be received at a user terminal 14A-N. The output may or may not be received through a network connection 16 which may or may not incorporate a firewall 18. It is fully contemplated that computer network 16 can be comprised of any one or more of a variety of computer communication configurations including but not limited to local area network (LAN), a wide area network (WAN), a wireless network, an intranet, an extranet, or the Internet.

The inputs may be entered into a computer program containing computer executable instructions. The program may be a spreadsheet program implemented in an enterprise information system. The enterprise information system may be an ORACLE based information system. The inputs may be entered manually or automatically while in communication with the one or more operation lines of the organization. The one or more activity steps may be accomplished manually or automatically. In one embodiment, users manually filter and scale the automatically inputted data in order to generate reports for further analysis. The one or more outputs may be generated by the spreadsheet program automatically or manually.

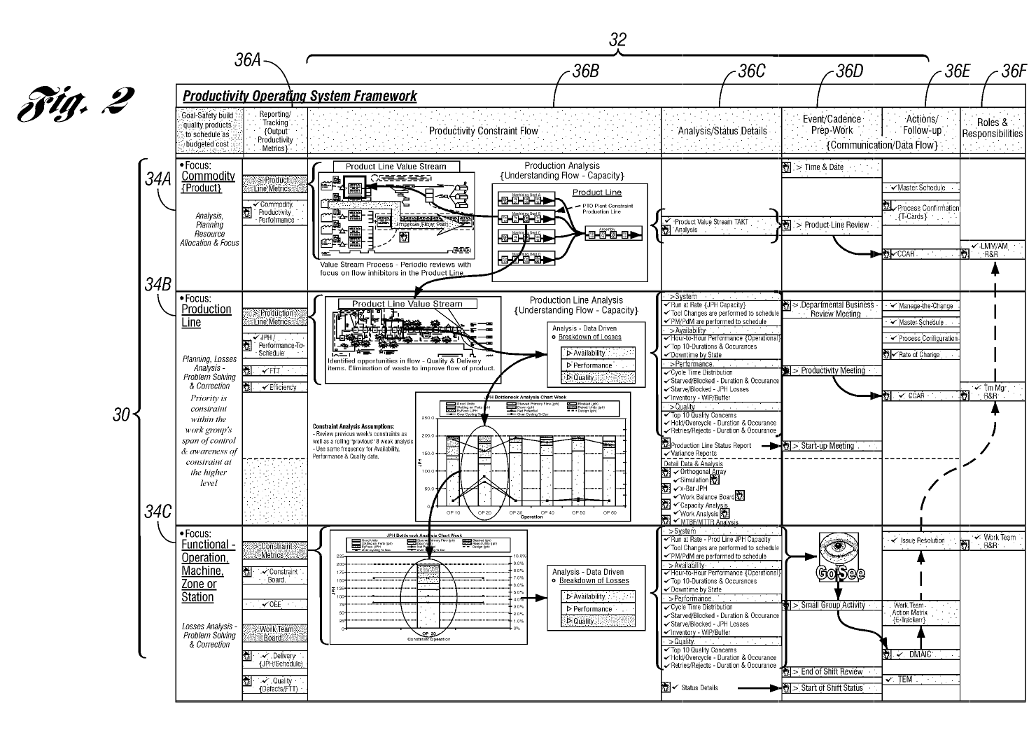

FIG. 2 shows a schematic framework for implementing one or more embodiments of the present invention. As stated above, the productivity matrix may include a first array 30 which, in one embodiment, may be the horizontal dimension of the matrix. The matrix may also include a second array 32 which, in one embodiment, may be a vertical dimension of the matrix. The interrelationship of the first array 30 to the second array 32 may generate a plurality of matrix events which may include at least one input, at least one output, and at least one activity step for generating the output from the input. The coordination of the input, the activity step, and the output may enable standardization of a business entity's applications to improve productivity improvement.

The first array 30 may include a number of elements that may be interrelated to each other. In one embodiment, the elements of the first array 30 may be a hierarchy based on a span of control of a business entity's employee assigned to that element. The plurality of elements may describe a focus level, e.g, work stream, within the business entity. For example, one element may be a commodity level focus 34A. The span of control of this work stream may include lean manufacturing managers (LMM) and/or area managers (AM) who may be responsible for defining and managing productivity objectives. Another element may be a production line focus 34B. The span of control of this focus level may include Team Managers (TM) who may be responsible for day-to-day operations of the productivity flow of products within a business entity (e.g., a manufacturing plant) and for meeting, sustaining, and driving productivity objectives. Another element may be a functional focus 34C. The span of control of this focus level may include work team members who may be responsible for running floor level activities to keep productivity levels maintained for the production line and improving constraint performance. In one embodiment, the hierarchy between these elements may comprise, in order of highest to lowest span of control, the commodity level 34A, the production line level 34B, and the functional level 34C.

The second array 32 may include a number of elements that may be interrelated to each other. In one embodiment, the elements may be objectives of a number of matrix events and may be used to operationalize the business entity's work streams with events, information, and data for each work stream. One non-limiting example of an element of the second array 32 may be a reporting/tracking element 36A. The reporting/tracking element 36A may refer to the productivity metrics that measure the efficacy of a business entity's productivity within each work stream. Another non-limiting example may be a productivity constraint flow element 36B which may refer to a study of the inhibitors of productivity flow within each work stream. Another example may be an analysis element 36C which may include breaking down the productivity inhibitors to determine the source of productivity losses. Another example may be an event/cadence element 36D which may refer to managing constraints through standardized events and data. Another example may be an actions/follow-up element 36E which may refer to action follow-up to ensure constraint problem solving and the use of an issue resolution process. Another example may be a roles and responsibilities element 36F which may refer to the accountability of operationalizing the productivity system.

The elements of the second array 32 may pertain to answering essential questions regarding the productivity process: “what is the measure of productivity?,” “what and where are the productivity constraints and issues?,” “why are these constraints affecting productivity?,” “how and when will these productivity issues be answered and resolved, if at all?,” “what further action does the problem require?,” and “who is/are the responsible parties for each productivity process?” These questions may be answered according to one or more elements of the first array 30.

The synergy of the first 30 and second arrays 32, in conjunction with the plurality of events of the matrix, may create a productivity flow that is standardized and organized and includes common cadence, action, and follow-up. Accordingly, manufacturing personnel may be able to focus their efforts on managing productivity and waste reduction without a lot of wasted time. Furthermore, productivity training may be low because of the standardized approach, new programs may be deployed without altering the productivity process, and personnel may freely move within the company without needing to learn new productivity methodologies.

### What is the Measure of Productivity?

In every work stream of the matrix, there may be a need in the manufacturing process to understand the factors that may be affecting productivity. Managers may be able to accomplish this by reporting and tracking productivity. There may be one or more ways of reporting and tracking productivity at one work stream and may generally be referred to as “productivity metrics.”

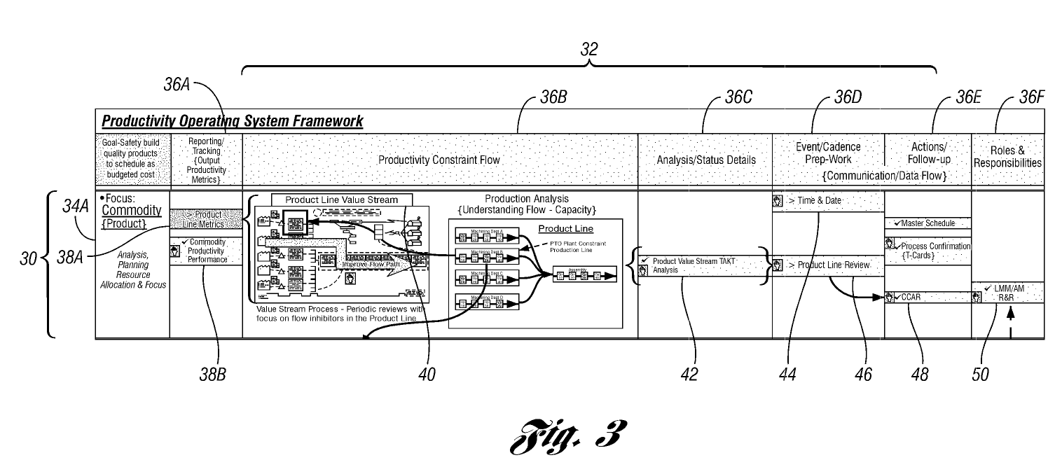

### Commodity Product Level (FIG. 3)

One example of a productivity metric may be a commodity productivity performance (CPP) 38. The CPP 38A may measure the overall commodity level 34A performance outputs. To determine the CPP 38A, there may be one or more inputs, outputs, and activity steps to determine the output from the input.

There may be three inputs required relating to commodity level 34A productivity: (1) efficiency, (2) performance-to-schedule, and (3) status to customer demand.

The efficiency input may be a plurality of monthly values of production performance efficiency and year-to-date (YTD) overall performance measured in percentage of efficiency. The output may be graph trends based on a monthly or YTD basis of each of the inputs. Each month may include at least two graphed values: (1) the percentage of efficiency and (2) the efficiency objective. The values may be graphed in any manner known in the art. For example, the graph may be a color-coded bar graph, line graph or a combination of both. A year to date graph may also be generated to represent the measured efficiency on a yearly basis.

The performance to schedule input may measure the number of produced products compared to those scheduled to be produced. The output may be graph trends based on a monthly or YTD basis of each of the inputs. Each month may include at least two values: (1) the actual number produced and (2) the scheduled number to be produced. A YTD graph may also be generated to represent the measured performance to schedule on a yearly basis.

The status to customer demand input may refer to the number of produced products compared to the scheduled to be produced products represented by code type (i.e., fault conditions/equipment losses such as downtime, starved, blocked, quality losses, and the like). The measurements may be outputted in at least one graph according to monthly increments and/or YTD increments. Each month may include a plurality of codes. The codes may be alphanumeric or numeric. The codes may be translated into a user-friendly form (e.g., “plain English”). A status to customer demand graph may be generated according to any manner known in the art. For example, the graph may be a color coded bar graph, line graph, pie graph, or any combination of graphs. The graph illustrates the number of items produced compared to the number of items scheduled based on code type. A YTD graph may also be generated to represent the measured performance of products produced and scheduled to be produced on a yearly basis.

The activity steps relating to determining the CPP 38A may include receiving the measured values into a program that may manipulate the inputted data to produce the graph trends i.e., the output. The combination of all the values and graph trends may generate the CPP 38A. One of ordinary skill in the art will know and understand the manner and technology used to graph the entered data.

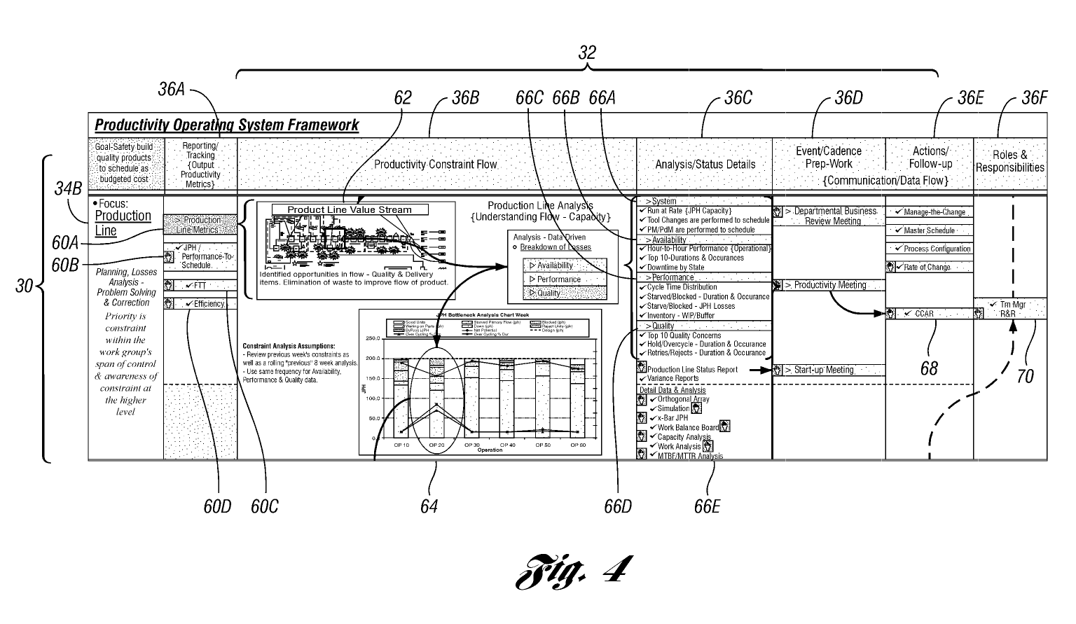

### Production Line Level (FIG. 4)

There may be a need in the manufacturing process to understand the constraints affecting the production line in terms of running at a productive rate and achieving scheduled objectives. A TM 70, who may be responsible for the production line level 34B, may begin accomplishing this understanding through a variety of inputs associated at the production line level 34B. The output at the production line level 34B may be production line metrics 60A used to determine the constraints affecting the operation line.

In one embodiment, a first input may be jobs-per-hour (JPH)/performance-to-schedule 60B. JPH may refer to the number of “good” units produced with respect to actual production time. JPH may be represented as follows in Equation (1):

$$J P H = \frac{Number of Good Units Produced}{Actual Production Time} \qquad ( 1 )$$

Performance to schedule may be the actual units produced compared to the scheduled number of units. This may also be referred to as a scorecard for the business entity.

JPH and Performance to Schedule 60B may be trended on a graph. For JPH, the graph's y-axis may be the number of good units produced and the x-axis may be the actual production time. For Performance to Schedule, the y-axis may represent the number of units while the x-axis may include the months of the year. Each month may include at least two values: (1) the actual number of units produced and (2) the number of scheduled units. A Performance to Schedule graph may be generated according to any manner known in the art. For example, the graph may be a color coded bar graph, line graph, data plots, or any combination of graphs.

A second input may be First Time Through (FTT) 60C capability at a specific Evaluation Point (EP) and Roll Throughput Yield (RTY). FTT may be a percentage of units at the EP that complete a process and meet quality guidelines without being scrapped, rerun, retested, returned or diverted into an offline repair area. Products that are scrapped, rerun, retested, returned or diverted into an offline repair area may also be referred to as “defect units.” FTT may be used to determine quality performance of a process and begin the process of determining the root causes of quality losses at the EP. RTY may represent an evaluation of the FTT capability of all EPs of a production line.

FTT 60C may be represented as follows in Equation (2):

$$F T T = \frac{Units entering the operation - Defect Units}{Units entering the Operation} \qquad ( 2 )$$

RTY may be represented as follows in Equation (3):

RTY=[Evaluation Point 1 (FTT)]×[Evaluation Point 2 [Evaluation Point N (FTT)]

The data values may be inputted into a spreadsheet or other graphing program to generate a trending chart. A trending chart may be generated to represent the trend of FTT 60C on a monthly basis over a year. In one embodiment, the trending chart my be a trending comparison of FTT 60C to Retries on a monthly basis over a year. For example, the values may be graphed in a data plot. The y-axis may represent the FTT percentage and the x-axis may represent months of the year. At least two data plots may be represented on the graph: (1) FTT and (2) Re-try FTT. Re-try FTT may represent the FTT of the re-tried products. Additionally, a target line may be generated on the graph to serve as a benchmark. The data values to generate the graph may be include the number of re-tried products, the percentage of FTT of the products, the percentage of FTT of retries, and target value. Target values may be expressed as a percentage. Other charts may be generated including, but not limited to, a chart of year-to-date FTT and Retries average, year-to-date number of retries, and a retries by month graph. One of ordinary skill in the art will know and understand the manner and technology to generate a chart.

A third input may be Efficiency 60D of the production line. Efficiency 60D may be a measure of system performance expressed as a percentage. Efficiency 60D may be expressed as follows in Equation (4):

$$Efficiency = \frac{Actual J P H}{100 \% Design} \qquad ( 4 )$$

Actual JPH may be the number of “good” units produced in a production process during actual production time. “Actual production time” may be any time that excludes planned breaks, lunch, events, meetings, or downtime. Actual downtime may be represented as follows in Equation (5):

$$Actual J P H ( monthly ) = \frac{Number of Products produced}{Production hours}$$

100% Design JPH may be the number of engineered units per hour capability of the system as known or documented in the production line. 100% Design JPH may be represented as follows in Equation (6):

$$100 \% Design J P H ( monthly ) = \frac{\begin{matrix}Scheduled number of \\ products to be produced\end{matrix}}{Scheduled production hours} \qquad ( 6 )$$

The data values may be manipulated for generating trending charts. The data values may be entered into a spreadsheet or other graphing program containing computer executable instructions for generating a trending chart. The monthly Efficiency 60D trending chart may have percentage values on the y-axis representing the efficiency percentages of the production line and the months of the year on the x-axis. Data plots of the monthly efficiency percentages may be graphed. Additionally, a target line may be presented representing the benchmark value for efficiency. The graphs may be bar graphs, line graphs, data plots, or any combination of graphs known in the art. Furthermore, the graphs may be color coded according to the various values.

Year-to-date (YTD) Efficiency 60D values may also be determined. The Actual JPH may be determined in the same manner as determining monthly values. The Design JPH for a year is a constant value that may only change if an engineering change is made to one or more operation lines. The year-to-date values may also be graphed. The graphs may be bar graphs, line graphs, data plots, or any combination of graphs known in the art. Furthermore, the graphs may be color coded according to the various values.

The coordination of the various inputs, activity steps, and outputs of the production line may generate an overall production line metrics output 60A.

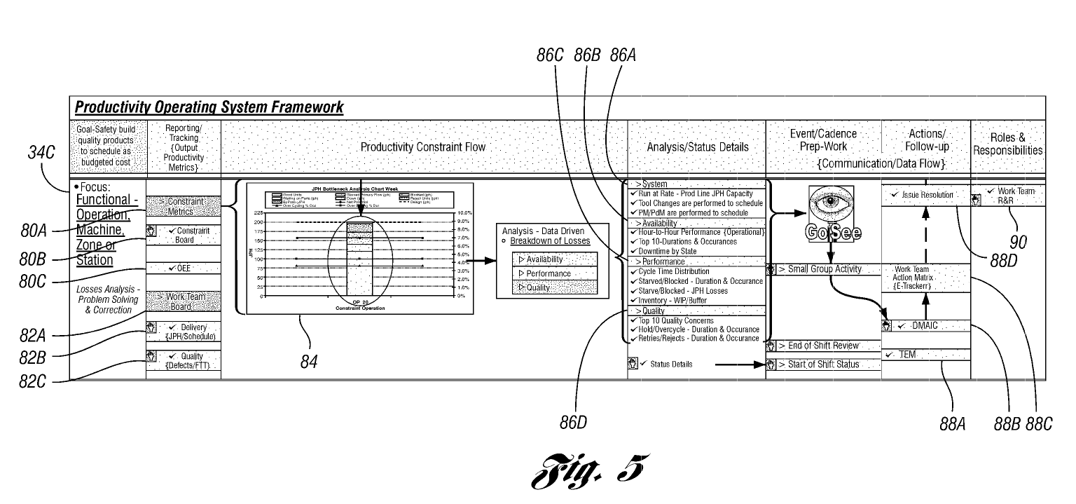

### Functional Level (FIG. 5)

There may be a need to understand the productivity factors associated with the floor level operations of the manufacturing entity. The Work Team members 90 may be able to assess the factors affecting productivity with a variety of productivity metric inputs associated with the functional line level. The output at the functional level 34C may be constraint metrics 80A and a Work Team Board 82A.

A first input may be a number of elements comprising a constraint activity board 80B. The constraint activity board 80B may be used to document, communicate and focus actions and trends of constraint functions. The constraint activity board 80B may accomplish its function by documenting hour-by-hour productivity status for each shift at the functional work stream 34C. The hour by hour documentation may include, but not be limited to, a targeted and actual hourly count of jobs-per-hour (JPH), causal factors of downtime losses, quality defect counts with causal factors, a before and after hourly count of inventory, a constraint JPH shift average, and a constraint cycle time.

Other elements of the constraint activity board 80B may include daily JPH trending, a preventive maintenance (PM) completion chart, an action matrix (problem deck) with constraint items highlighted, and open PM and Total Equipment Maintenance (TEM) tickets in predetermined windows of opportunities. For example, the windows of opportunities may be 15 minute actions, 30 minute actions, 1 hour actions, or greater than 2 hour actions to measure the productivity metric at the functioning work stream. These inputs may be determined and inputted by functional level 34C employees. In one embodiment, the constraint board is not electronic and is referenced and updated by function level 34C employees working at one or more operation lines.

A second input may be operational equipment effectiveness (OEE) 80C. OEE 80C may be a measure of the ability of a piece of equipment or process to consistently produce quality products at a designed cycle rate by measuring the availability, performance efficiency, and quality rate of a machine. Individually, OEE 80C may allow work team members to determine major equipment losses and use the determined data to problem solve for continuous improvement. OEE 80C, in one embodiment, may be represented with the following formula as represented by Equation (7):

OEE=Quality×Performance×Availability (7)

where:

Quality=(total parts built−total defect)/total parts built

Performance=(total parts built×ideal cycle time)/operating time

Availability=operating time/net available time wherein:

Operating time=net available time−downtime

Net Available Time=Total Schedule Time−Planned Downtime

One of ordinary skill in the art will know and understand how to determine the values comprising the quality, performance, and availability values according to equation 7. In one embodiment, the values to determine OEE 80E may be calculated and entered on a weekly basis for an entire year. Furthermore, the values may be graphed to determine the trend of OEE 80E on a weekly basis over one year. For example, the y-axis may be percentage values and the x-axis may each week of the year. There may also be a target value. The graphs may be bar graphs, line graphs, data plots, or any combination of graphs known in the art. Furthermore, the graphs may be color coded according to the various values.

A third input to determine the functional level 34C productivity metric may be a Work Team Board (WTB) 82A. The WTB 82A may represent data relating to performance to meeting objective targets using determined key quality and delivery metrics. The WTB 82A may be mapped as a color coded scheme of current status to meeting the target. The data for the metrics may be the number of products produced on the floor.

The Delivery Metrics 82B may be mapped in the following manner:

1. Green=made scheduled production in scheduled hours

2. Yellow=made scheduled production in excessive hours

3. Red=didn't make scheduled production/shut customer down

4. X=non-working shifts or days

5. JPH trending chart

The Quality metrics 82C may be mapped in the following manner:

1. Green=days meeting first time through (FTT) targets.

2. Yellow=FTT less than target or containment procedure invoked

3. Orange=defect reached an internal customer

4. Red=defect reached an external customer

5. X=non-working shifts or days

6. FTT trending chart

The activity steps may include receiving the measured data (i.e. the number of products produced on the floor) into a spreadsheet program that may manipulate the inputted data to produce graph trends (as output). The graph trends may be used to assess the constraint of the productivity flow. One of ordinary skill in the art will know and understand the various ways to graph the entered data. The graphs may be bar graphs, line graphs, data plots, or any combination of graphs known in the art. What and where are the productivity constraints and issues?

An understanding of the constraints in the number of work streams may provide for understanding the source of the constraints. That is, what and where are the productivity constraints regarding product flow? Understanding the source of constraints may include comprehending the inhibitors and losses to product flow at each work stream level in order to manage these constraints and sustain and improve productivity. Furthermore, the analysis may include an analysis of how product flow in one work stream may affect the product flow in the remaining work streams. Therefore, the constraint of product flow in one work stream may be related to one or more factors associated with product flow in another work stream. For example, the overall commodity level 34A flow may be tied to the constraint of the production line 34B. Similarly, the overall production line 34B flow may be tied to the constraint of the functional level 34C. More specifically, the constraint at the commodity level 34A may be equal to a constraint in the production line 34B while the production line constraint 34B may be equal to an individual asset or machine that is a constraint (i.e., at the functional level 34C).

In one embodiment, the metrics of each work stream 34A-C may be used as inputs to determine issues affecting product flow through at least one work stream 34A-C. For example, the product line metric 38A from the commodity level 34A, the production line metric 60A from the production line level 34B, and the constraint metric 80A from the functional level 34C may serve as one or more inputs to determine the source of productivity constraints.

Using a process called value stream mapping (VSM), the output pertaining to what and where the constraints may exist may be determined. VSM may be used to determine the product flow constraints, such as waste and flow inhibitors, at two or more work streams. For example, VSM may be used at the commodity level 34A and the production line level 34B. Commodity level 34A VSM 40 may be used to determine the production line level 34B constraint of the commodity level 34A. That is, the VSM 40 process may determine the flow inhibitors in the production line 34B affecting the commodity level 34A. Similarly, a production line level 34B VSM 62 may be used to determine the functional level 34C constraints of the production line 34B. That is, the VSM 62 process may include determining the opportunities in the flow and using quality and delivery items to eliminate waste and improve product flow.

In one embodiment, VSM 40, 62 processes may be used in the commodity level 34A and the production line level 34B. In another embodiment, VSM 40,62 is used in all three workstreams.

### Why are These Constraints Affecting Productivity?

An analysis of the productivity processes to determine the reasons behind its constraints may also improve productivity in the manufacturing process. By pinpointing the constraints, a Manager may further verify the conclusions of the analysis.

### Commodity Level (FIG. 3)

One analysis tool may be TAKT analysis 42 to determine the degree of time for meeting customer demand. In one embodiment, TAKT 42 may be conducted at the commodity level 34A work stream. Accordingly, a Manager may be able to assess, for example, where the lag time is and how to improve the time of delivering the product to the customer. A TAKT analysis 42 may be based on the customer's requirements or demand rates and therefore, may be specific to each customer. For example, if a customer requires 60 units of product per hour, the manufacturing process should sustain a constant product flow (“TAKT”) of 60 seconds per unit. Customer demand rate can also be exemplified according to Equation (8) below:

$$TAKT = \frac{\frac{3600 seconds ( s )}{hours}}{Customer Demand} \qquad ( 8 )$$

Customer demand rates may be based on units per day or week. Other non-limiting inputs of a TAKT analysis 42 may be (1) the operation line's benchmark design rate based on JPH performance and operating pattern (i.e., the operation line's shifts and hours), (2) the current performance of the operation line based on JPH performance and operating pattern, and (3) “safety stock” available based in hours (e.g., the amount of inventory between the production line and the customer to account for possible production line inefficiencies). JPH may be calculated according to equation 1.

The combination of the data may be inputted and compiled into a chart and graphed according to the results of one or more operation lines in the manufacturing process. The results may show the one or more operation lines' TAKT capability (i.e., degree of success) to meet customer demand. For example, based on the determined JPH and the actual performance of the one or more operation lines, a TAKT performance difference between each line can be determined. The result may be detailed according to an amount of time over or under the ideal TAKT performance in seconds. A change to any of the inputs may proportionately change the TAKT results 42.

The data may be graphed. The graphs may be bar graphs, line graphs, data plots, or any combination of graphs known in the art. Furthermore, the graphs may be color coded according to the various values.

A Manager may be able to utilize this information to determine, for example, which production lines are causing the constraint in flow of product to the end customer. A Manager may then place focus on these tardy production lines to improve productivity.

### Production Line Level (FIG. 4) and Functional Level (FIG. 5)

The source of the production line 34B and functional 34C constraints may be assessed from a Jobs-per-Hour (JPH) analysis. The analysis may include charts that may be broken down to produced additional charts and data to pinpoint the source of the losses caused at the production line 34B and functional 34C work streams. Additionally, the performance of the JPH constraint over time may be analyzed for determining the sources of these losses. Furthermore, the performance of the end of the line JPH may be used as an overall “picture” of efficiency of the production line 34B and functional work 34C streams.

In one embodiment, JPH data may be accumulated and charted to assess the overall efficiency of the production line 34B and functional 34A work streams. This may be referred to as a “System” analysis 66A, 86A. JPH data determinations may be accomplished through the productivity metrics of the production line 34B and functional 34C work stream 60A, 80A. The data may be further analyzed to determine the source of any losses. The analyzed JPH data may be referred to as “Run at Rate Charts” for the system analysis 86A. The Run at Rate charts, in one embodiment, may be include “percent of Hour at Rate” on the y-axis and “JPH count range” on the x-axis. In one embodiment, the “JPH count range” may be divided into JPH counts of 25.

The data may be analyzed and charted according to a weekly basis. In one embodiment, the chart may illustrate the disparity of JPH between each week. The run at rate charts may indicate the performance of JPH over time by showing the percentage of hours running at a JPH rate. Accordingly, the JPH efficiency of the operation line may be visualized. For example, the run at rate chart may illustrated that the production line 34A and functional 34B work streams run at a rate of 125-150 JPH about 45% of the time. Alternatively, the run at rate charts can be visualized on a weekly basis such that a comparison can be made on a weekly basis. For example, within the range of 125-150 JPH count ranges, there may be a number of different values, each representing the percent and hours of rate during a particular week. Each value may be color coded to clearly delineate the different weeks. The charted graphs may be bar graphs, line graphs, data plots, or any combination of graphs known in the art.

Other tools may also be used by Managers to provide an overall picture of the running of the production line and the functional work streams. For example, Managers may be provided with a summary report to detail the status of the current conditions of the production line 34B and functional 34C work streams. The summary report may provide for an analysis of the plant's operations so that Managers may be able to make informed decisions regarding the plant or warehouse's operations (i.e. “Detail Status Reports”). The Managers may also receive variance reports to review aspects of cost, labor, inventory, and other pertinent information, tooling reports to report unscheduled tool change frequencies, and Total Equipment Maintenance (TEM) reports, including Preventative Maintenance (PM) and Predictive Maintenance (PdM) reports.

Data for determining the JPH constraint efficiency may come from a JPH constraint analysis 64. The JPH constraint analysis chart 64 may have an associated losses data table. The data may show over cycle losses information. The data may be divided according to the operation of the production line 34B and may indicate which operation may be the bottleneck (i.e., the “net potential”).

Assessing the source of losses may require the losses to be broken down to allow for a focused analysis of productivity. For example, in one embodiment, the productivity losses may be broken down into either availability 66B, 86B, performance 66C, 86C or quality 66D, 86D of the production line 34B or functional 34C work streams. Accordingly, Managers may concentrate on improving productivity in the focused loss breakdown. There may be data and charts associated with each breakdown to assist in determining the crux of the productivity inefficiencies.

The availability breakdown detail 66B, 86B may refer to the operational issues regarding the production line 34B and functional 34C work stream productivity. The availability detail 66B, 86B may review downtime, faults, or other operational issues. Using JPH analysis 64, 84 as a framework, an analysis of each of the operation lines may be conducted. It is contemplated that the operation line causing the bottleneck will be the focus of the analysis. For example, the availability detail 66B, 86B may be further analyzed for a specific operation line. Graphic charts from determined data may be generated for visual presentation. For example, charts may be generated to display JPH on an hourly basis and may serve as a presentation of where the losses exist on a hourly basis per week.

Data may also indicate JPH values according to production line downtime states. Non-limiting examples of downtime states include bypass, tool change, set-up, shutdown, e-stop, waiting attention, and repair. A graph may include “JPH” on the y-axis and “Station” (i.e., operation line) on the x-axis thus signifying the JPH downtime states per station. Another chart may be a display of the major causes of downtime for an area or operation line. The major causes may be ranked by duration or occurrences. Each chart may be outputted using the JPH data generated from the operation line as inputs. The graphs may be bar graphs, line graphs, data plots, or any combination of graphs known in the art. Furthermore, the graphs may be color coded according to the various values.

The performance detail 66C, 86C of the productivity loss may refer to the cycle time of the production line 34B and functional 34C work streams. The breakdown may aid in determining whether the cycle time may be the reason for the production line 34B or functional 34C work stream bottleneck. By analyzing JPH of the operation line 64, 84, a performance detail of each operation line may be conducted. Visual representations (e.g., charts and graphs) using JPH data per operation line may be generated to illustrate and visualize the source of the loss in the production line 34B and functional 34C work stream performance. For example, a cycle time distribution chart may be generated as part of the performance detail 66C, 86C. The cycle time chart may detail the number of cycles falling within certain percentages of cycle time per operation line. In one embodiment, this may be illustrated as number of cycles on the y-axis and the operation line on the x-axis. The graphed values may represent the number of cycles at a predetermined cycle time. The predetermined cycle times may be represented as a percentage. The percentages may be represented as (1) greater than 30% slow, (2) less than design time to 30% slow, (3) design time to 10% fast, (4) 10% to 20% fast, and (5) greater than 20% fast. Calculation of the number of cycles per operation line in the JPH constraint can be accomplished according to any manner known by one of ordinary skill in the art. The graphs may be bar graphs, line graphs, data plots, or any combination of graphs known in the art. Furthermore, the graphs may be color coded according to the various values.

Other data in the performance detail 66C, 86C may illustrate the incidents of starved constraints and blocked constraints by duration and occurrences. There may be visual representations (e.g., graphs and charts) of this data. A constraint in a blocked state may occur when downstream operations from a constraint cannot handle the output of the constraint. A constraint in a starved state may occur when upstream operation from a constraint cannot provide input to the constraint. The one or more charts may illustrate the duration and number of occurrences for each time one or more of the operation lines are in a blocked or starved state. The data may be itemized by operation line and illustrate (1) blocked duration based on idling minutes and (2) blocked occurrences. The on or more charts may illustrate this data on a weekly basis. There may be 2 y-axes: (1) the duration and (2) the occurrences. The x-axis may be the manufacturing operation line. Determining the values of the time and number of occurrences of a starved or blocked state can be performed in any manner known in the art. The graphs may be at least two of a bar graph, line graph, data plot, or any combination of graphs known in the art. Furthermore, the graphs may be color coded according to the various values (i.e., duration and occurrences).

A trend chart illustrating JPH blocked and starved trends per each operation line may be generated. The blocked and starved JPH losses may indicate the constraint for the production line 34B and functional 34C work streams. The data may be the determined JPH values for the blocked and starved states of each operation line. The chart may be a plot of these data values. The y-axis may be the JPH values and the x-axis may be the operation lines. The point at which the starved JPH loss plot crosses with the blocked JPH loss plot may signify the location of the constraint of one or more operation lines. JPH data for the blocked and starved states may be determined from Equation 1.

A trend chart illustrating an analysis of the inventory work in progress (WIP) by count point may be generated. The report illustrates the average number of parts at a given count point and may be trended over one or more days, weeks, or months. WIP Float charts assist in determining if inventory levels are being maintained particularly around the constraint at the operation line. The graph may be a bar graph, line graph, data plot, or any combination of graphs known in the art. Furthermore, the graph may be color coded according to the various values.

The Quality breakdown detail 66D, 86D of the productivity loss may refer to defects in the production line 34B and functional 34C work streams. For example, the FTT rate of the production line may be an element of the quality detail 66D, 86D. The analysis of the Quality detail 66D, 86D may provide for insight into whether the quality of the production line 34B or functional 34C work stream may be a bottleneck for the production line 34B or functional 34B work streams. By analyzing JPH of the one or more operation lines 64, 84, a determination of the quality losses may be accomplished per operation line of the production process.

JPH data may be inputted from the JPH data to accomplish the quality detail analysis 66D, 86D. For example, a quality concern chart may be generated which includes the type of concern on the y-axis and a value on the x-axis (e.g., number of concerns). The chart may indicate on which problems/concerns to focus based on the number of concerns that have generated for that problem.

Other data and charts may aid in assisting the source of losses in the Quality detail 66D, 86D. For example, a hold/overcycle duration and occurrences chart and data may be generated and manipulated to assess whether the hold button and/or over cycle time are quality factors that may affect productivity. The data may include overcycle and hold button duration and number of occurrences per each operation line of the production process. The duration may be based on a unit of time (e.g., minutes). The chart may have two y-axes: (1) duration on one y-axis and (2) the occurrence on a second y-axis. The operation line numbers may be on the x-axis. The graph may be a bar graph, line graph, data plot, or any combination of graphs known in the art. Furthermore, the graph may be color coded according to the various values. For example, overcycle duration (represented as a bar) and overcycle occurrence (represented as a line graph) may be of the same color while hold button duration (represented as a bar) and hold button occurrences (represented as a line graph) may be of a different color. The data values are determined automatically as is known in the art.

In one embodiment, the operation line number located on the x-axis of the chart may be a hyperlink to an overcycle and hold report which may provide the details (e.g., time state, time end, and duration, etc) for each operation line selected.

A retry and reject data and chart may also be generated under the Quality detail 66D, 86D. The information may be used as insight into the number of occurrences and duration of each operation lines' rejects and retries. Managers may use this information to obtain further insight into the quality of the production line 34B and/or functional 34C work streams. The data table may be populated to provide for the duration and occurrences of retries and rejects. The duration may be represented in a unit of time (e.g., minutes). A graph may provide for a visual presentation of the data and include two y-axes: (1) duration and (2) number of occurrences. The x-axis may include a number of operation line numbers.

The graph may be a bar graph, line graph, data plot, or any combination of graphs known in the art. Furthermore, the graph may be color coded according to the various values. The data and graph may be generated for any time frame such as on a weekly, monthly, or yearly basis. Furthermore, the data values are determined automatically as is known in the art.

In one embodiment, the operation line numbers located on the x-axis of the chart may be a hyperlink to a reject and retries report which may provide the details (e.g., time start, product type, and serial number) for each operation line selected.

Upon conducting the analysis, the source of the constraint may or may not be identified at each work stream. The output generated from the analysis step may be used as inputs for further examination and follow-up. For example, the inputs may be used to determine how the productivity issue may be identified and addressed.

How will these Productivity Issues be Identified and Addressed, if at all?

A time and data management tool 44 (hereinafter referred to as “TD Document”) may be generated for prioritizing time and information for improving productivity processes. The TD Document 44 may aid in determining the effect time management has on improving productivity levels. Additionally, the TD Document may aid personnel to obtain and utilize the necessary data to support the time managed events. The TD Document 44, in one embodiment, may be a calendar which may display events at scheduled times and days for meeting productivity improvement objectives. Accordingly, the TD Document 44 may assist in reducing wasted time because of redundancy and/or lack of necessity.

The TD Document 44 may be used to support all work stream 34A-C of the business entity. Each work stream 34A-C may have standard activities and events that address the productivity issues related to that work stream. For example, at the commodity level 34A there may be a product line review 46. Similarly, at the production line level 34B and the functional level 34C, there may be productivity related meetings and activities related to problem solving productivity inefficiencies.

An “event matrix” may be utilized in order to organize and standardize the meetings and activities and each work stream 34A-C. The event matrix may be used in conjunction with the TD Document 44. The event matrix, furthermore, may serve as a separate framework for operationalizing time and data management in order to further organize and standardize productivity improvement. For example, a user (e.g., a Manager) may use the event matrix to organize the flow of a meeting or an activity scheduled on the TD Document 44. The event matrix may be itemized according to the type of meeting or activity and include data such as when the meeting or activity would occur (e.g., daily, monthly, bi-weekly, etc), what reports/metrics are associated with that meeting and would need to be analyzed, specific elements of the metrics that require analysis, follow-up activities at each event, and an identification of those individuals responsible for organizing and meeting objectives at each level. In this way, a focus on productivity improvement may be standardized and made more efficient.

Based on the period of time that each meeting or event occurs (e.g., bi-weekly, daily, etc), data relating to the previous period's productivity performance may be received and utilized to facilitate meetings and activities. The document may be linked to productivity performance data such as scorecards, master schedules, and meeting agendas

The meeting and activities may result in follow-up actions to meet productivity objectives such as eliminating constraints and losses.

What further Action does the Problem Require?

The productivity issues may require further action for resolution or confirmation of meeting productivity objectives. FIG. 6 is an exemplary embodiment of the resolution process. The resolution and/or confirmation of these issues may be standardized throughout the business entity. Information and results generated from the productivity cadence events may be used to create follow-up actions at each work stream including, but not limited to, problem solving or elevating certain issues to higher focus levels.

In one embodiment, the results from the productivity meetings and activities may generate an automatic issue resolution process that may start at the functional level 88D. A member may elevate the issue using the issue resolution process 88D through electronic communication means including via e-mail or via a form filled out and transmitted over a network. Managers at the commodity 34A or production line 34B work streams may either resolve these issues if in their capability, elevate the issue further (i.e., in the case of a production line manager), or elevate to an external source. For example, if a Work Team cannot resolve a certain issue or it may be out of their control based on the established safety, quality, and productivity objectives block 100, the problem is identified block 102 and inputted into an action matrix (described in further detail below) 104. The issues are prioritized block 106 and a problem solving session is generated 108 using DMAIC (as will be further described below) as a framework. A business case is created block 110 and enters the escalation process block 112. Each manager may spend a predetermined time trying to resolve the issue (e.g., one week) until it is elevated. The issue may be elevated from a team manager block 114 to an area manager block 116 and from an area manager block 116 to a steering committee 118. Each manager/committee may support the business case and provide resources block 120 or they may not support the business case but provide feedback to the teams block 122. In either case, a corrections report may be generated 124 (as will be further described below).

An example of a problem solving DMAIC methodology may be a six-sigma methodology 88B. The six-sigma methodology 88B is broken down into five major phases: (1) defining the problem, (2) measuring the problem, (3) analyzing the problem, (4) improving the problem, and (5) controlling the problem. The problem solving exercise may focus on certain elements of the business entity's operations. For example, the focus may be based on safety, quality, delivery, cost, morale, or environmental issues. This may also be referred to as “SQDCME metrics.” Thus, data and information to problem solve the productivity issues may be received using SQDCME as the framework. Upon receiving the data, manufacturing personnel may strategize on resolving these issues.

An action deck or matrix 88C may be used to determine which issues to resolve and/or elevate. In one embodiment, information received into the matrix may include an identification of the issue, actions being addressed by the issue, which physical area of the business entity may be affected (e.g., operations, station, zone, etc), which functional areas may be affected (e.g., SQDCME), timing information, accountability (who is responsible), corrective actions, constraint issues, and issues elevated through issue resolution process.

In another embodiment, a concern and corrective action report (CCAR) 68 may be generated. The CCAR 68 receives data from the issue resolution process 88D. The information may include SQDCME, the type of concern, any correction actions and recommendations, who is responsible, a target date, the issue resolution progress, the actual date when the issue was met and possible follow-up actions. In one embodiment, the CCAR 68 may only be used by the production line 34B and commodity levels 34A.

Who is/are the Responsible Parties for each Productivity Process?

A business entity may have personnel assigned to the productivity improvement of individual work stream 36F. Accordingly, productivity improvement is further standardized by assigning accountability 36F. Activities of each personnel may be performed online or offline. Each personnel may (1) receive communications, issues, or tasks (2) determine steps to resolve or accomplish these activities, and (3) resolve or fulfill these activities. Further details of roles and responsibilities at each work stream has been described through the disclosure.

### Other Features

In one embodiment, there may be an electronic tool (hereinafter referred to as “Guidebook”) that provides ready access to a plurality of information pertaining to the standardization of productivity improvement. The Guidebook may be organized according to the standardized framework. For example, information may be accessed through a plurality of electronic tabs representing the various elements of the vertical array. Each tab may include information related to the subject matter of the selected tab. Non-limiting examples of information within each tab includes definitions, objectives, equations, and various examples of inputs, activity steps, and outputs.

The Guidebook may be automatically formatted for printing by a user. Accordingly, the Guidebook may be printed as a book without further formatting by the user. For example, the electronic tabs may be automatically printed as index tabs to allow for ready access to the information by the user. Accordingly, a user can have efficient and ready access to productivity information to further improve productivity efficiency.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A computer-implemented method for improving manufacturing productivity of a business entity's operations, the method comprising:
receiving at least two elements of a first array and at least two elements of a second array, wherein the first and second arrays are interrelated to produce a productivity matrix;
receiving a number of matrix events, wherein each matrix event is interrelated to an element in the first array and an element of the second array, and each matrix event includes at least one input, at least one output, and at least one activity step for obtaining the output from the input;
receiving the at least one input and the at least one activity step for each matrix event; and
outputting the at least one output for each matrix event, wherein the input, activity step, and output of each matrix event together enables standardization of a business entity's operations to improve productivity improvement.

2. The computer-implemented method of claim 1 wherein the elements of the first array are in a hierarchical scheme comprising a number of the business entity's work streams, the hierarchy based on a span of control of at least one employee of the business entity assigned to each work stream.

3. The computer-implemented method of claim 2 wherein the number of work streams includes a commodity focus, a production line focus, and a functional focus.

4. The computer-implemented method of claim 1 wherein the at least two elements of the second array are a number of event objectives associated with each work stream to serve as a guide for standardizing the business entity's improvement and productivity operations.

5. The computer-implemented method of claim 4 wherein the number of event objectives includes: metrics, problem identification, problem analysis, problem solving, follow-up, and roles and responsibilities.

6. The computer-implemented method of claim 1 wherein the at least one input includes productivity related data, the at least one activity step includes organizing the inputted productivity related data, and the output includes one or more productivity metrics generated based on the inputted and organized productivity related data for identifying and further evaluating one or more constraints affecting the business entity's productivity.

7. The computer-implemented method of claim 1 wherein the number of matrix events includes at least one productivity constraint in the business entity's operations, and the coordination of the at least one input, the at least one activity step, and the at least one output of each of the number of matrix events serves to identify and address the at least one productivity constraint.

8. The method of claim 1 wherein the at least one input is a number of data generated from one or more productivity metrics associated with one of at least two elements of the first array, the at least one activity step is a value stream mapping of the element, and the at least one output is one or more productivity constraints affecting the productivity of the element.

9. A computer-implemented system for improving manufacturing productivity of a business entity's operations, comprising at least one computer configured to:
receive at least two elements of a first array and at least two elements of a second array, wherein the first and second arrays are interrelated to produce a productivity matrix;
receive a number of matrix events, wherein each matrix event is interrelated to an element in the first array and an element of the second array, and each matrix events includes at least one input, at least one output, and at least one activity step for obtaining the output from the input;
receive the at least one input and the at least one activity step for each matrix event; and
output the at least one output for each matrix event, wherein the input, activity step, and output of each matrix event together enables standardization of a business entity's operations to improve productivity improvement.

10. The computer-implemented system of claim 9 wherein the elements of the first array are in a hierarchical scheme comprising a number of the business entity's work streams, the hierarchy based on a span of control of at least one employee of the business entity assigned to each work stream.

11. The computer-implemented method of claim 10 wherein the number of work streams includes a commodity focus, a production line focus, and a functional focus.

12. The computer-implemented system of claim 9 wherein the at least two elements of the second array are a number of event objectives associated with each work stream to serve as a guide for standardizing the business entity's improvement and productivity operations.

13. The computer-implemented system of claim 12 wherein the number of event objectives includes: metrics, problem identification, problem analysis, problem solving, follow-up, and roles and responsibilities.

14. The computer-implemented system of claim 9 wherein the at least one input includes productivity related data, the at least one activity step includes organizing the inputted productivity related data, and the output includes one or more productivity metrics for at least one work stream of a business entity generated based on the inputted and organized productivity related data for identifying and further evaluating one or more constraints affecting the business entity's productivity.

15. The computer-implemented system of claim 9 wherein the number of matrix events includes at least one productivity constraint in the business entity's operations, and the coordination of the at least one input, the at least one activity step, and the at least one output of each of the number of matrix events serves to identify and resolve the at least one productivity constraint.

16. The system of claim 9 wherein the at least one input is a number of data generated from one or more productivity metrics associated with one of the at least two elements of the first array, the at least one activity step is a value stream mapping of the element, and the at least one output is one or more productivity constraints affecting the productivity of the element.

17. A computer-implemented method for improving manufacturing productivity of a business entity's operations, the method comprising:
supplying at least two elements of a first array and at least two elements of a second array wherein the first array and second array are interrelated to produce a productivity matrix; and
generating a number of matrix events wherein each matrix event is interrelated to an element in the first array and an element of the second array, and each matrix events includes at least one input, at least one output, and at least one activity step for obtaining the output from the input.

18. The computer implemented method of claim 17 wherein the elements of the first array are in a hierarchical scheme comprising a number of the business entity's work streams, the hierarchy based on a span of control of at least one employee of the business entity assigned to each work stream and the at least two elements of the second array are a number of event objectives associated with each work stream to serve as a guide for standardizing the business entity's improvement and productivity operations.

19. The computer implemented method of claim 18 wherein the number of work streams includes a commodity focus, a production line focus, and a functional focus.

20. The computer-implemented method of claim 18 wherein the number of event objectives includes: metrics, problem identification, problem analysis, problem solving, follow-up, and roles and responsibilities.
